(19) United States
(12) Patent Application Publication
(10) Pub. No.: US 2007/0063792 A1
(43) Pub. Date: Mar. 22, 2007

(54) Circuit interconnection which reduces cross talk, simultaneous switching noise, required decoupling capacitance and method therefor

(76) Inventor: Clifford Edward Clark, Knoxville, TN (US)

Correspondence Address: Clifford Clark, 5400 Wildercliff Lane, Knoxville, TN, 37918, US

(21) Appl. No.: 11/545,332

(22) Filed: Oct. 10, 2006

Related U.S. Application Data
(63) Continuation-in-part of application No. 10/160,465, filed on May 30, 2002, now Pat. No. 7,102,463.

(51) Int. Cl. H01P 1/18; H01P 9/00

(52) U.S. Cl. 333/156

(57) ABSTRACT

The purpose of the described invention is to provide a means to reduce cross talk (coupled signal distortion) between adjacent signal transmissions, to reduce simultaneous switching noise, and to reduce the need for decoupling capacitance. The method used to obtain these objectives is misaligning the rising or falling edges of adjacent signals.

### RELATED APPLICATION

This application is related to U.S. patent application Ser. No. 10/160,465 filed May 30, 2002 in the name of Clifford E. Clark as the inventor, and entitled “A PRINTED CIRCUIT BOARD (PCB) WHICH MINIMIZES CROSS TALK AND REFLECTIONS AND METHOD THEREFOR”. The above patent application is hereby incorporated by reference.

### FIELD OF THE INVENTION

This invention relates to semiconductor devices and more specifically to the interconnection of these devices. The method described herein, incorporated into the interconnection between electronic devices, results in reduced crosstalk, reduced simultaneous switching effects, and reduced need for decoupling capacitance.

### BACKGROUND OF THE INVENTION

Electrical signals originating from electronic devices often do so in an approximately synchronous, edge transition, aligned fashion. When the positive or negative going edges of each signal propagate along an interconnection from one device to another device they create associated electric fields. The electric fields of one signal in turn, couple undesired effects on adjacent signal interconnections. When signal edges are approximately aligned, edges induce undesired effects via electric fields (electro magnetic and electrostatic) on nearby signal edges. An illustration of signal edges approximately aligned are found in FIG. 1, and an illustration of electric fields of approximately aligned signal edges are found in FIG. 2.

The above undesired effect on signal edges can be reduced by misaligning the edges of nearby signals. As a consequence, the electric fields of signal edges couple their effects on the steady state portion of the nearby signal, rather than inducing effects on the positive going or negative going edges. An illustration of signal edges misaligned are found in FIG. 3, and an illustration of electric fields of misaligned signal edges are found in FIG. 4.

Discrete electrical signal levels are typically separated by some difference in voltage or current. This difference in voltage or current levels provides noise immunity, and makes the different signals levels unambiguous. An electronic device receiving discrete signal levels is better able to tolerate the undesired coupling effects mentioned above when the undesirable effects occur during the steady state portion of a signal rather than during the positive or negative going edge transitions.

Since the undesired coupling effects mentioned above have less detrimental impact when they occur to the steady state portion of a signal rather than the positive going or negative going edge transitions, it is preferable to move the undesired coupling effects away from the edge transitions.

Misaligning signal edges to move undesired effects constitutes the novelty of the within described method. Purposefully misaligning signal edges to move undesired coupling effects has been previously described within the U.S. patent application Ser. No. 10/160,465 filed May 30, 2002 in the name of Clifford E. Clark as the inventor, and entitled “A PRINTED CIRCUIT BOARD (PCB) WHICH MINIMIZES CROSS TALK AND REFLECTIONS AND METHOD THEREFOR”. The above mentioned patent application is incorporated by reference.

Occurrences of signal edge misalignment in electronic systems have previously been unintentional, undesired, and considered a nuisance by electronic designers. This author describes a method of purposefully, intentionally misaligning signal edge transitions. Misalignment of signal edges is accomplished by described methods.

Within synchronous electronic systems, arriving signals must be received approximately edge aligned. Since unintentional skew or misalignment of signal edges has occurred without purpose in previous designs, often due to manufacturing or design variation, methods to de-skew or realign the signal edges have been previous developed and mentioned within publicly available documentation. The use of specific implementations of delay to de-skew or realign unintentional misalignment of signal edges is described by many sources. Examples of specific methods for de-skewing or realigning signal edges are:

High-Speed Digital Design, A Handbook of Black Magic, author Howard W. Johnson and Martin Graham in 1993, pages 354 to 360.

U.S. Pat. No. 6,940,362 Otaki

U.S. Pat. No. 5,777,526 Kawasaki, Kazuhiro

However, these publications do not give directive to intentionally and constructively misalign signal edges to reduce undesired effects.

Additionally, the described method may be used to reduce simultaneous switching noise. Simultaneous switching noise occurs, and increases as the number of driving structures of an electrical device transition states at approximately the same time.

An inductive voltage drop occurs between the power and ground connections to a driving device as a result of the summation of the near instantaneous currents drawn by simultaneous driving devices. As a result, the output waveforms of the driving devices become distorted. By misaligning the edges or state transitions, the instantaneous currents drawn from the power and ground connections are reduced. The inductive voltage drop between the power and ground connections are consequently reduced. The output waveform distortion of driving device is consequently reduced.

Another benefit of the described method is that it also reduces the amount of capacitive coupling required in a system design. Capacitive decoupling is used to store energy to provide current for surges required by circuits. If edges are misaligned, the surge current is reduced, and the need for capacitive decoupling is reduced.

### SUMMARY OF THE INVENTION

An objective of the present invention is to provide a means to reduce cross talk (coupled signal distortion) between adjacent signal transmissions, to reduce simultaneous switching noise, and to reduce the need for decoupling capacitance. The method used to obtain these objectives is misaligning the rising or falling edges of adjacent signals. This approach is novel. Prior designs attempt to minimize or eliminate misalignment of adjacent rising or falling edges due to manufacturing variations, design variations, and power and ground constraints. Methods for misaligning signal edges are described.

### BRIEF DESCRIPTION OF THE EMBODIMENTS

In accordance with another embodiment of the present invention and U.S. patent application Ser. No. 10/160,465 filed May 30, 2002 in the name of Clifford E. Clark as the inventor, and entitled “A PRINTED CIRCUIT BOARD (PCB) WHICH MINIMIZES CROSS TALK AND REFLECTIONS AND METHOD THEREFOR”, an electrical interconnect is disclosed. Adjacent electrical signals have their rising and falling edges misaligned with respect to one another. Several methods may be used to misalign signal edges such as inserting delay within the path of the signal relative to an adjacent signal. Delay can be inserted before the driving device, within the driving device or after the driving device. However, the placement of delay is not limited to these positions. Misaligning synchronizing signals that control other signals may be employed to misalign adjacent signal edges as well. These signals may be misaligned by the use of delay elements, gates, storage elements, phase lock loops, digital delay lines, etc . . .

### BRIEF DESCRIPTIONS OF THE DRAWINGS

FIG. 1 illustrates approximately aligned signal edges propagating from driving devices.

FIG. 2 depicts the interacting electric fields of approximately aligned signal edges. Note that while the graphical representation of electric fields is lines of flux, in reality, the electric fields are generally continuous rather than discrete. Hence the phrase “electric fields” will be used rather than electric field lines.

FIG. 3 illustrates purposeful misalignment of signal edges or transitions of state.

FIG. 4 illustrates purposeful misalignment of signal edges or transitions of state and the subsequent reduced interaction of electric fields.

FIG. 5 is an example implementation of misaligning signal edges by the use of delay. On the driving side, the invention is represented to misalign rising and falling edges. On the receiving side, publicly available techniques are employed to realign the misaligned rising and falling edges, if and when realignment becomes necessary. The right side of the illustration is included purely as tutorial for readers that wish to implement the described novel design detailed within this document.

FIGS. 5 through 10 illustrate a multitude of implementations of the described novel design detailed within this document. These figures are not inclusive of all possible implementations but are given for purposes of illustration and tutorial.

FIG. 11 is an illustration of misaligning adjacent signal edges by a method that implicitly uses delay, yet no specific delay element is readily apparent. Two adjacent signals edges are misaligned by using different synchronizing signals.

FIG. 12 is an extension of FIG. 11 that uses a phase locked loop or digital delay line or multiple clocks or strobes or delay elements to create two different synchronizing signals which misalign the rising or falling edges of “signal 1” and “signal 2”.

FIG. 13 uses synchronizing signals with misaligned rising or falling edges to enable the driving devices to subsequently have their rising or falling edges misaligned. Misalignment of the synchronizing signals can be accomplished with methods described in descriptions of FIGS. 5 through 11.

FIG. 14 illustrates that misaligning signal edges and the methods for misaligning signal edges can be applies to differential drivers as well as single ended drivers with similar benefit.

FIG. 15 emphatically illustrates that delay elements can be placed within the conductive medium to achieve the benefits discussed previously.

FIG. 16 emphatically illustrates delay elements placed within the driving and receiving devices.

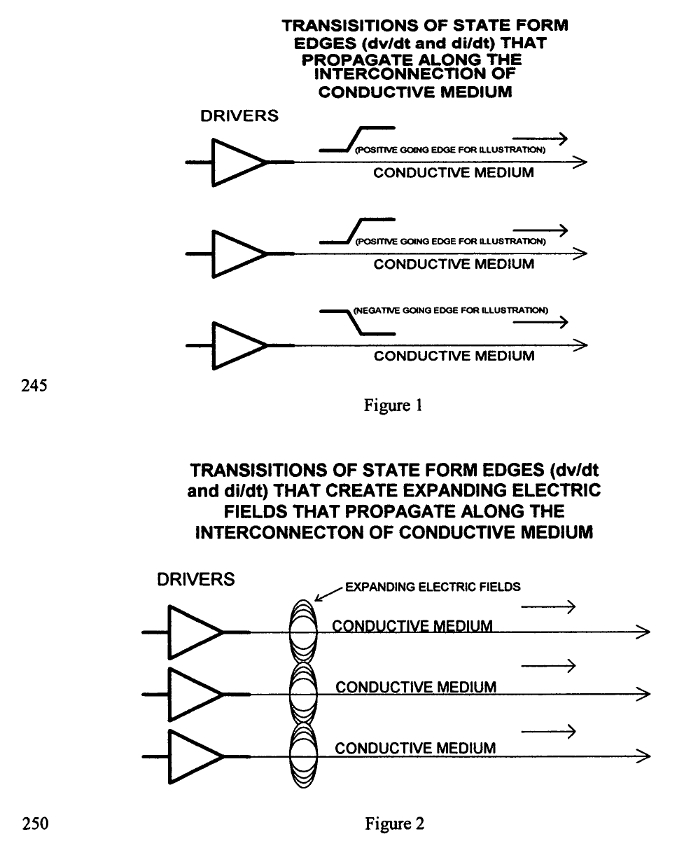

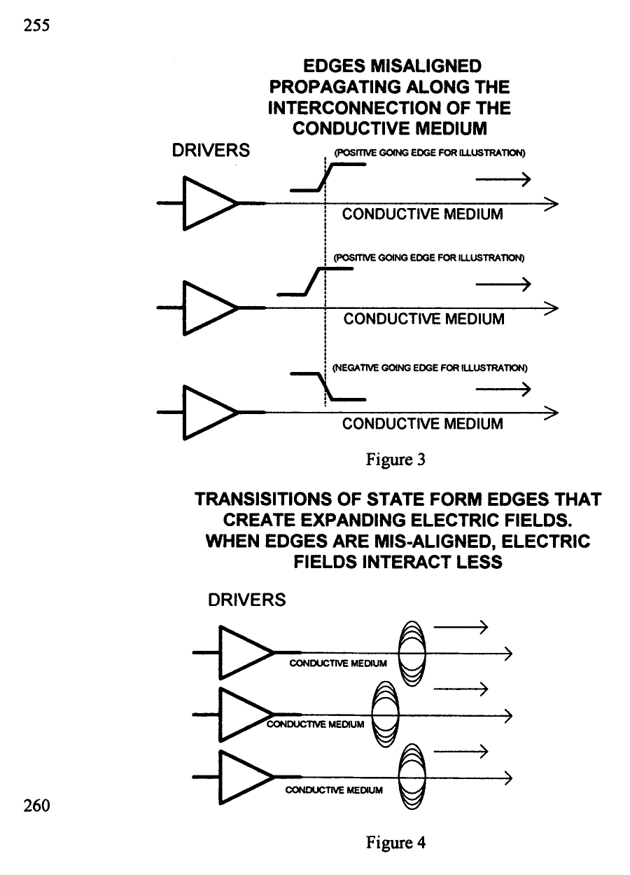

### DETAILED DESCRIPTION OF THE INVENTION

Reference the BACK GROUND OF THE INVENTION section as an aid for comprehension of the DETAILED DESCRIPTION. Misaligning adjacent electrical signal edges reduces undesired effects. Methods to achieve misalignment are detailed.

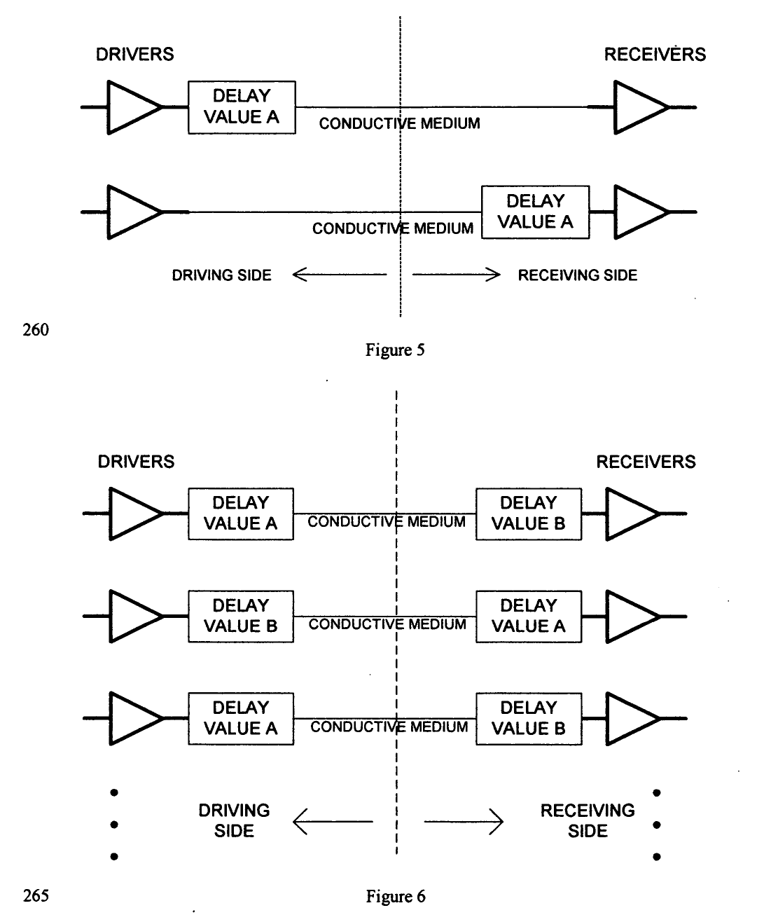

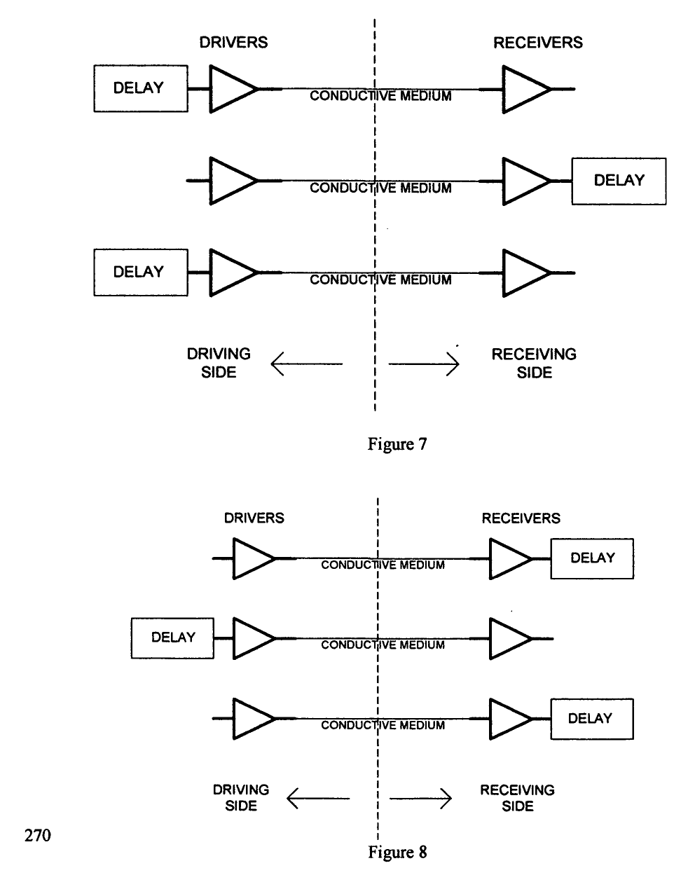

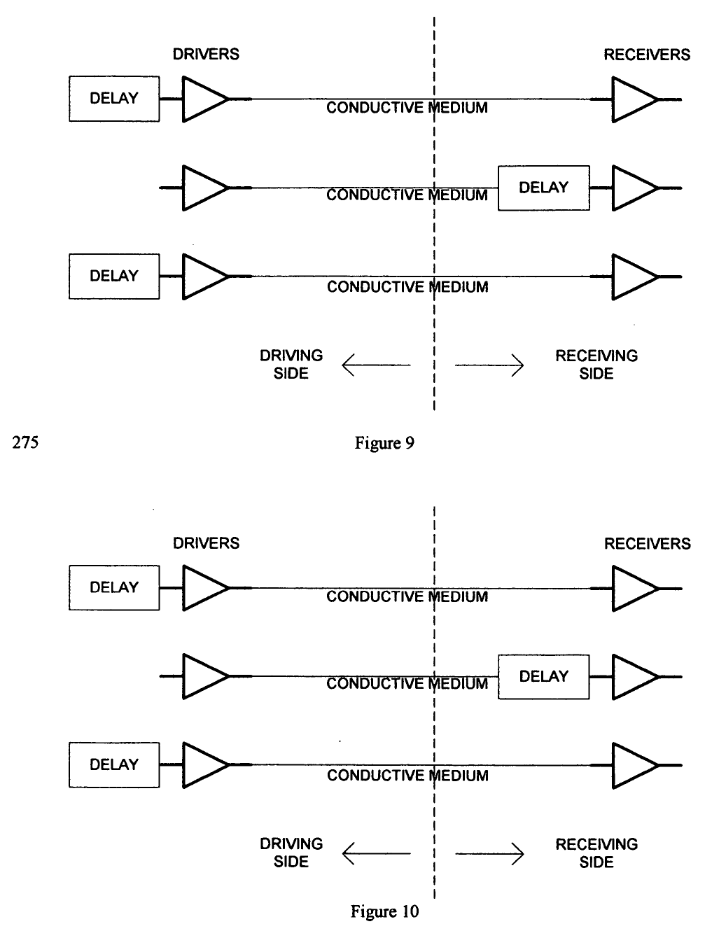

A method for misaligning signal edges is inserting delay into the propagation paths of adjacent signals. Please reference FIG. 5. Delay may be inserted into the propagation paths by varying amounts so as to misalign signal edges of nearby signals. Delay may be inserted before the driving device. Delay may be inserted within the structure of the driving device. Delay may be inserted after driving device. Please reference FIGS. 5, through 10 and 15 and 16 as exemplifications of the use of delay within the signal path to misalign signal edges.

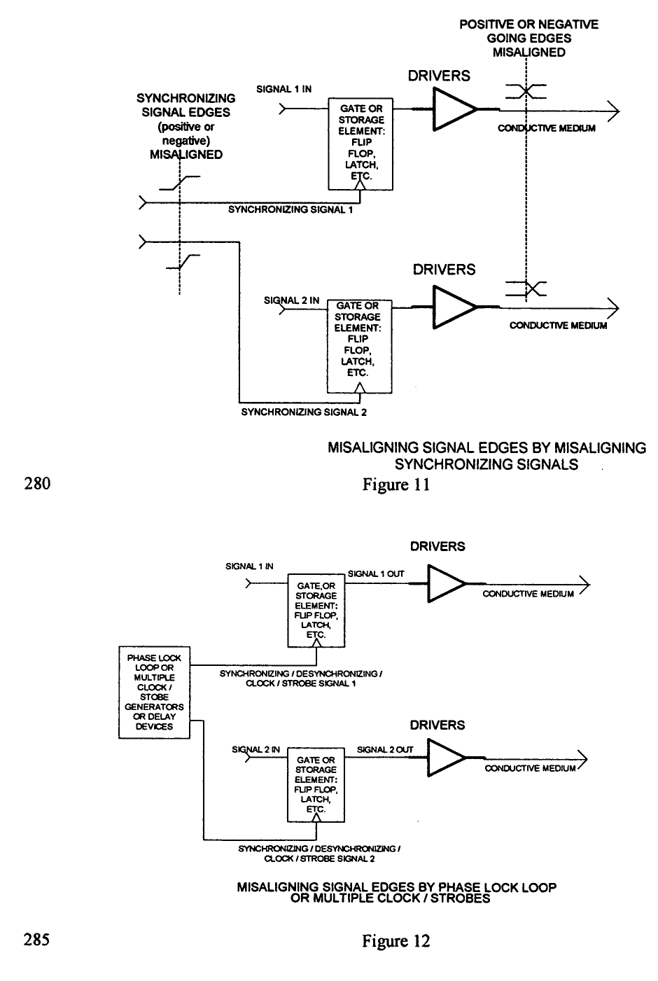

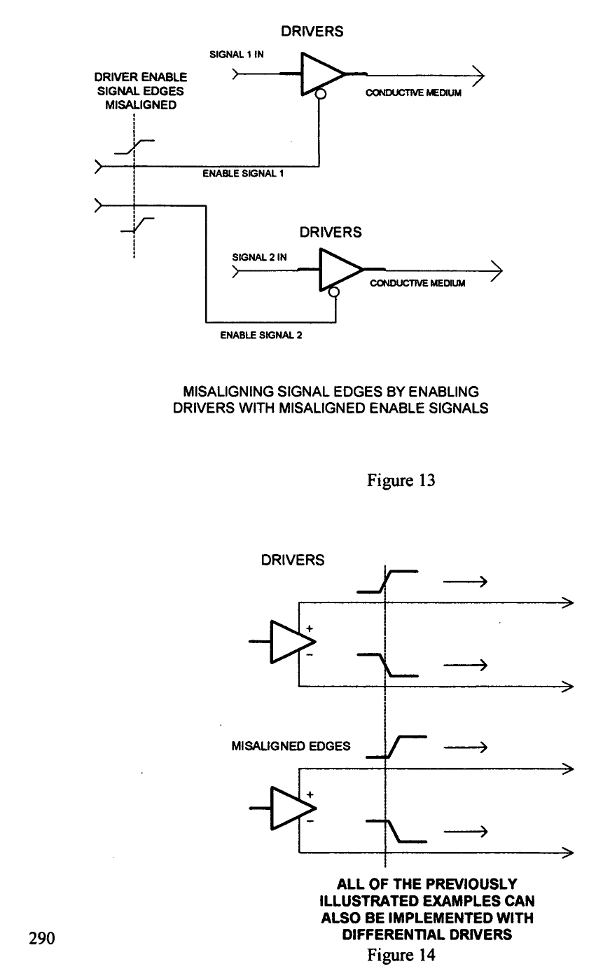

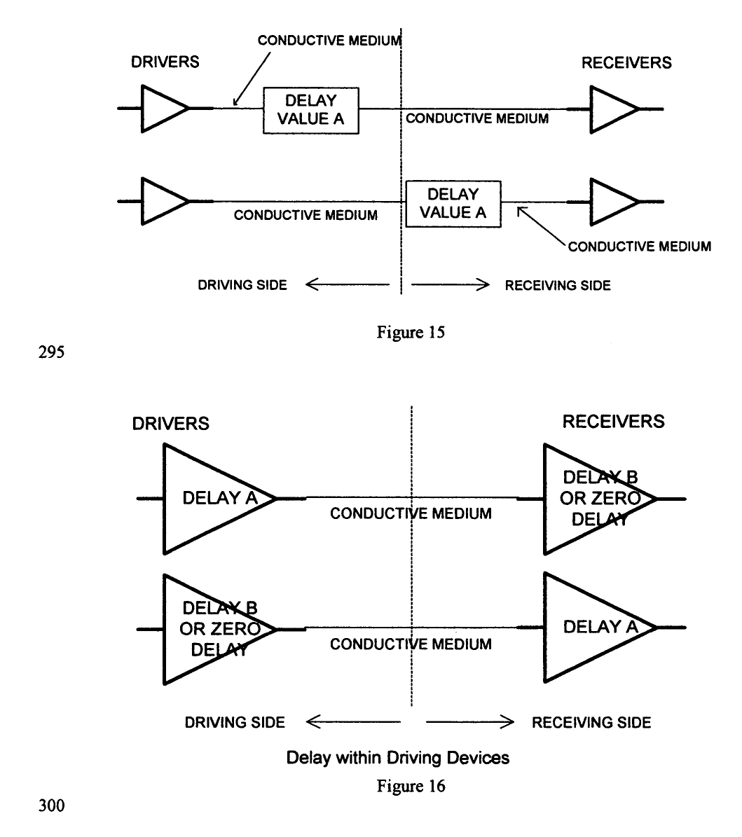

Another method of misaligning signal edges is the use of different “synchronizing” or “enable” signals. This method for misaligning signal edges is depicted in FIGS. 11 through 13. As depicted, a phase lock loop or digital delay line, or multiple clock/strobe generators can be used to control storage elements or gates that control the primary signals. Additionally, misaligned enable signals can be used to enable the driving devices such that their associated signals consequently have misaligned edges (FIG. 13).

What is claimed is:

1. An electrical interconnection with associated rising or falling signal edges that are misaligned from an adjacent interconnection's associated rising or falling signal edges by the use of delay within the path of propagation.

2. An electrical interconnection with associated rising or falling signal edges that are misaligned from an from an adjacent interconnection's associated rising or falling signal edges by the use of delay inserted in the electrical path, before the driving agent.

3. An electrical interconnection with associated rising or falling signal edges that are misaligned from an adjacent interconnection's associated rising or falling signal edges by the use of delay inserted within the driving agent.

4. An electrical interconnection with associated rising or falling signal edges that are misaligned from an adjacent interconnection's associated rising or falling signal edges by the use of delay inserted in the electrical path, after the driving agent.

5. An electrical interconnection with associated rising or falling signal edges that are misaligned from an adjacent interconnection's associated rising or falling signal edges by the use of delay inserted within the electrically conductive medium between the driving agent and receiving agent.

6. An electrical interconnection with associated rising or falling signal edges that are misaligned from an adjacent interconnection's associated rising or falling signal edges by the use of synchronizing signals whose associated rising or falling edges are misaligned from one another.

7. An electrical interconnection with associated rising or falling signal edges that are misaligned from an adjacent interconnection's associated rising or falling signal edges by the use of synchronizing signals whose associated rising or falling edges are misaligned from one by the use of delay within one or more of the synchronizing signal's path.

8. An electrical interconnection with associated rising or falling signal edges that are misaligned from an adjacent interconnection's associated rising or falling signal edges by the use of synchronizing signals whose associated rising or falling edges are misaligned from one by the use of phase locked loop.

9. An electrical interconnection with associated rising or falling signal edges that are misaligned from an adjacent interconnection's associated rising or falling signal edges by the use of synchronizing signals whose associated rising or falling edges are misaligned from one another by the use of a digital delay line.

10. An electrical interconnection with associated rising or falling signal edges misaligned by driving devices whose enable signals are misaligned from one another.

11. An electrical interconnection with associated rising or falling signal edges misaligned by driving devices whose enable signals are misaligned from one another by the use of delay within the enable signal's propagation path.

12. An electrical interconnection with associated rising or falling signal edges misaligned by driving devices whose enable signals are misaligned from one another by the use of digital delay line within the enable signal's propagation path.

13. An electrical interconnection with associated rising or falling signal edges misaligned by driving devices whose enable signals are misaligned from one another by the use of phase locked loop to misalign enable signals edges.

14. An electrical interconnection with associated rising or falling signal edges misaligned by design from an adjacent interconnection's associated rising or falling signal edges.
